(19) United States
(12) Patent Application Publication
(10) Pub. No.: US 2024/0147882 A1
(43) Pub. Date: May 9, 2024

(54) Tool Change System for Ground Cultivating Machines

(71) Applicant: Amazonen-Werke H. Dreyer SE & Co. KG, Hasbergen (DE)

(72) Inventors: Robert DIETRICH, Flößberg (DE); Rainer RESCH, Hagen a TW (DE); Tom MAHLER, Leipzig (DE)

(73) Assignee: Amazonen-Werke H. Dreyer SE & Co. KG, Hasbergen (DE)

(21) Appl. No.: 18/279,987

(22) PCT Filed: Aug. 24, 2021
(86) PCT No.: PCT/EP2021/073321

§ 371 Date: Sep. 1, 2023

(30) Foreign Application Priority Data
Mar. 4, 2021 (DE) 10 2021 105 179.7

(51) Int. Cl. A01B 15/06; A01B 35/22

(52) U.S. Cl. CPC A01B 15/06; A01B 35/225

(57) ABSTRACT

The disclosure relates to a tool change system for agricultural ground cultivating machines, comprising: a ground cultivation tool, which is designed to be moved through soil for ground cultivation; a tool carrier, on which the ground cultivation tool is arranged; and a locking device; wherein the ground cultivation tool and the tool carrier together form an engagement mechanism, by means of which the ground cultivation tool and the tool carrier can be non-destructively and releasably brought into engagement with one another.

### CROSS REFERENCE TO RELATED APPLICATIONS

The present application claims priority under 35 U.S.C. § 365 to PCT/EP2021/073321 filed on Aug. 24, 2021 and under 35 U.S.C. § 119(a) to German Application No. 10 2021 105 179.7 filed on Mar. 4, 2021.

### BACKGROUND

The present disclosure relates to a tool change system for ground cultivating machines, a ground cultivation tool, and a method for mounting a ground cultivation tool.

Agricultural ground cultivating machines, for example agricultural row crop cultivators, can be equipped with a tool change system which is intended to simplify and/or speed up changing the ground cultivation tools used. In hoeing technology, for example, share plates are used as ground cultivation tools, which are subject to comparatively high wear during use, so that regular tool changes are required. Furthermore, agricultural ground cultivating machines are commonly used with various ground cultivation tools which are adapted to a specific ground cultivating operation, a specific type of soil and/or to the needs of a specific crop.

In practice, quick-change tool systems, with in which the ground cultivation tool is to be screwed to the tool carrier by way of a screw, are often used. The screw head is there arranged on the underside of the ground cultivation tool so that it becomes clogged with soil and plant residues during the ground cultivating process, which means that it is often problematic to loosen the screw afterwards. In particular with high workloads, for example, when working in stony soil, the fastening screws used often fracture so that the ground cultivation tool detaches from the tool carrier during the working process, usually unnoticed by the machine operator. In practice, there is also the problem that a screw attachment comes loose after a long period of use, which can lead to canting of the ground cultivation tool during the ground cultivating process. Respective canting often leads to the ground cultivation tool being damaged. In addition, the required tightening forces of respective screw connections can only be generated using a suitable tool so that it is not possible to change the ground cultivation tool without tools. In practice, accessibility to the screw head located on the underside typically also poses a problem.

A corresponding tool change system, in which the tool is fastened by way of screws, is known, for example, from publication U.S. Pat. No. 4,799,555.

### SUMMARY

The object underlying the disclosure is therefore to simplify and/or speed up changing ground cultivation tools at an agricultural ground cultivating machine.

The object is satisfied by a tool change system of the kind mentioned at the outset, where the locking device of the tool change system according to the disclosure comprises a clamping lever by way of which the engagement mechanism can be locked.

When using a clamping lever, there is no need to fasten the ground cultivation tool with a screw or bolt attachment, so that no changing tool is needed to assemble and disassemble the ground cultivation tool. Due to the fact that fastening members, such as screws or bolts, are dispensed with, even high workloads during the ground cultivation do not pose any problem since the tool change system does not have any delicate fastening members that are at risk of fracture.

The ground cultivation tool can be, for example, a share plate. The tool change system is configured to be used with, for example, an agricultural row crop cultivator. The tool carrier preferably has an elongate basic shape. The tool carrier can be an integrally formed component. For example, the tool carrier is a carrier stick or a carrier rod. The tool carrier is preferably formed from metal or a metal alloy. The clamping lever preferably has an elongate basic shape. The clamping lever can be an integrally formed component. The clamping lever is preferably formed from metal or a metal alloy.

In a preferred embodiment of the tool change system according to the disclosure, the clamping lever has a locking section which can be inserted into a lever receiving recess of the engagement mechanism. The lever receiving recess is preferably arranged in the ground cultivation tool. By inserting the locking section of the clamping lever into the lever receiving recess, the engagement mechanism is preferably pre-locked. In order to bring about a final locking state, the clamping lever is preferably further moved to a locking position, where moving the clamping lever to a locking position is accompanied by clamping of the ground cultivation tool to the tool carrier. The lever receiving recess is preferably arranged in a rear free region of the ground cultivation tool. Once the ground cultivation tool and the tool carrier have been made to engage, the lever receiving recess is accessible from the rear side of the ground cultivation tool so that the clamping lever can be inserted in a simple manner from the rear and above. In this way, safe and simple assembly of the ground cultivation tool is possible, since no assembly processes have to be carried out on the underside of the ground cultivation tool.

In a further preferred embodiment of the tool change system according to the disclosure, the ground cultivation tool and the tool carrier can be clamped to one another by way of the clamping lever. When clamping the ground cultivation tool and the tool carrier, the ground cultivation tool is pushed or drawn backwards by the clamping lever. The ground cultivation tool and the tool carrier can initially perform a motion relative to one another when being clamped. By performing the relative motion of the ground cultivation tool and the tool carrier, they are positioned relative to one another and pre-locked onto one another. The ground cultivation tool and the tool carrier are clamped by preferably moving the clamping lever to a locking position once the clamping lever has been inserted into the lever receiving recess. For this purpose, the clamping lever is to be pivoted, for example, upwardly once the clamping lever has been inserted into the lever receiving recess. In the locking position, the clamping lever exerts a clamping force upon the ground cultivation tool and/or the tool carrier, by way of which the ground cultivation tool and the tool carrier are fastened to one another.

In the unclamped state, i.e. before the clamping lever is moved to the locking position, the engagement mechanism can allow a release motion of the ground cultivation tool and/or the tool carrier, by way of which the engagement between the ground cultivation tool and the tool carrier can be released. The clamping force caused by the clamping lever after the clamping lever has been moved to the locking position acts in the direction opposite to the release direction so that a release motion of the ground cultivation tool and/or the tool carrier is prevented by the clamping lever.

In a further development of the tool change system according to the disclosure, the clamping lever has a tool contact region which is configured to be pressed against the contour of the lever receiving recess when the ground cultivation tool and the tool carrier are clamped to one another. The tool contact region is preferably disposed in the locking section of the clamping lever which is inserted into the lever receiving recess of the engagement mechanism. When the clamping lever is moved to the locking position and/or is disposed in the locking position, the tool contact region of the clamping lever is in contact with the contour of the lever receiving recess.

In a further development of the tool change system according to the disclosure, the clamping lever has a carrier contact region which is configured to be pressed against a lever guide region of the tool carrier when the ground cultivation tool and the tool carrier are clamped to one another. When the clamping lever is moved to the locking position and/or is disposed in the locking position, the carrier contact region of the clamping lever is preferably in contact with the lever guide region of the tool carrier.

Furthermore, a tool change system according to the disclosure is advantageous in which the carrier contact region of the clamping lever has a convexly curved contact surface. The carrier contact region of the clamping lever preferably has a convex rounding. Alternatively or additionally, the lever guide region of the tool carrier can have a concavely curved contact surface. The lever guide region of the tool carrier preferably has a concave rounding. The convexly curved contact surface on the clamping lever and the concavely curved contact surface on the tool carrier preferably have matching radii. The convexly curved contact surface on the clamping lever and the concavely curved contact surface on the tool carrier preferably together form an open slide bearing for the clamping lever. The contact surfaces in the carrier contact region and in the lever guide region can be formed to be spherical, at least in sections.

In addition, a tool change system according to the disclosure is advantageous in which the carrier contact region and the lever guide region together form a rotary bearing for the clamping lever which allows for a guided rotational motion of the clamping lever across a pivot angle range. It is preferably necessary to perform the rotational motion of the clamping lever over the pivot angle range in order to move the clamping lever to the locking position after insertion into the lever-receiving recess.

The tool change system according to the disclosure is further developed advantageously in that the clamping lever is configured to be elastically deformed when the ground cultivation tool and the tool carrier are clamped to one another. The clamping lever is preferably elastically bent when the ground cultivation tool and the tool carrier are clamped to one another. The clamping lever can be, for example, a spring bar. The clamping lever is preferably elastically deformed, in particular elastically bent, when moved to the locking position.

In another preferred embodiment of the tool change system, the locking device has a retaining member which is configured to retain the clamping lever in a locking position in which the ground cultivation tool and the tool carrier are clamped to one another by way of the clamping lever. The rotary bearing is preferably arranged at a distance from the holding member so that a favorable lever ratio arises. By utilizing the leverage effect, a comparatively high clamping force clamping the ground cultivation tool and the tool carrier to one another can be generated using a comparatively small actuating force. In this way, a robust clamping lock of the ground cultivation tool and the tool carrier can be implemented despite dispensing with a separate assembly tool.

The clamping lever can therefore be moved to the locking position either by manual force or using an additional tool. The retaining member prevents the clamped clamping lever from snapping back. The retaining member can be, for example, a ring-shaped body The tool carrier can have a support for the retaining member which prevents the retaining member from dropping down in an uncontrolled manner when the retaining member is not affixed by the clamping lever. The retaining member can also be a hinged pin. The retaining member can be moved to an assembly auxiliary position in which the clamping lever is removably affixed to the retaining member so that the clamping lever is not lost when the ground cultivation tool is changed. The clamping lever can hang down loosely from the retaining member in the auxiliary assembly position.

In another preferred embodiment of the tool change system according to the disclosure, the clamping lever is configured to be elastically deformed in the locking position and/or to extend along a curved edge profile of the tool carrier in the locking position. The curved edge profile of the tool carrier, along which the clamping lever extends in the locking position, is preferably convex and/or a rear end edge of the tool carrier.

In order to prevent material such as soil and/or plant residues from collecting between the clamping lever and the tool carrier, which could prevent the intentional release of the clamping connection, the gap between the curved edge profile of the tool carrier and the clamping lever can be filled with an elastically deformable material in the locking position of the clamping lever. For this purpose, the elastically deformable material can be fastened, for example glued, onto the curved edge of the tool carrier and/or onto the clamping lever. The elastically deformable material can be, for example, foam rubber. The elastically deformable material only fills the gap elastically, but does not assume any closing and/or locking function. The elastically deformable material is disposed in a region protected from the soil flow so that the elastically deformable material is prevented from detaching from the clamping lever and/or from the tool carrier due to the soil flow. Due to the elastic deformability of the material, reliable and simple clamping and releasing of the clamping lever continues to be possible.

The tool change system according to the disclosure is further developed advantageously in that the engagement mechanism has one or more engagement bodies, where each engagement body is configured to engage in a receiving recess of the engagement mechanism. The one or more engagement bodies are preferably disposed on the underside of the tool carrier. The one or more engagement bodies are preferably integral components of the tool carrier. The one or more receiving recesses are preferably disposed in the ground cultivation tool. The one or more engagement bodies protrude preferably only slightly from the one or more receiving recesses such that the one or more engagement bodies are protected from wear due to contact with the soil flow. Furthermore, plate-shaped ground cultivation tools can exhibit different material thicknesses. Due to the locking by way of one or more engagement bodies, the compatibility of the ground cultivation tool and the tool carrier is not dependent on the material thickness of the ground cultivation tool. This results in a universal and flexibly replaceable engagement mechanism which is independent of the plate thickness of a plate-shaped ground cultivation tool.

In a further preferred embodiment of the tool change system according to the disclosure, an engagement body of the engagement mechanism is configured to engage in the lever receiving recess into which also the locking section of the clamping lever can be inserted. The lever receiving recess therefore receives both an engagement body as well as the locking section of the clamping lever. The lever receiving recess therefore serves to create an engaged state between the ground cultivation tool and the tool carrier and to implement clamping of the ground cultivation tool and the tool carrier with one another.

In another preferred embodiment of the tool change system according to the disclosure, the one or more engagement bodies have a contact surface which is configured to be pressed against a respective contact section of the inner contour of a receiving recess when the ground cultivation tool and the tool carrier are clamped. The inner contour of the receiving recess therefore serves as a counter bearing when the ground cultivation tool and the tool carrier are clamped by way of the clamping lever.

In another preferred embodiment of the tool change system according to the disclosure, the contact surface of the one or more engagement bodies and the contact section of the inner contour of the one or more receiving recesses have corresponding bevels. Due to the bevels, the ground cultivation tool and the tool carrier wedge into one another when clamped by way of the clamping lever. The ground cultivation tool fits to the tool carrier with almost no play. The clamping lever ensures that the fit is maintained without play during a processing operation so that the ground cultivation tool cannot cant and/or twist, even under the influence of ground cultivating forces. The engagement bodies preferably have bevel angles that match or differ from one another.

The inner contours of the receiving recesses preferably have bevel angles that match or differ from one another. The bevel angle on the bevels of the engagement bodies and the bevel angle on the bevels of the inner contours of the receiving recesses are preferably in a range between 30 degrees and 60 degrees, for example, 45 degrees.

Furthermore, markings for setting the position of the ground cultivation tool and/or for setting the working depth can be present on the tool carrier. The markings can form a scale for performing height adjustment. Due to the markings, a grating in the edge region of the tool carrier can be dispensed with.

In a further preferred embodiment of the tool change system according to the disclosure, the clamping lever is configured as a bent wire part. In particular, the clamping lever is configured as a spring clip. In this embodiment, the clamping lever can be formed to be U-shaped so that two open ends of the bent wire part are disposed directly opposite one another and/or a loop arises at the closed end of the bent wire part. The contour of the clamping lever can be mirror-symmetrical so that it arises from two wire ends extending symmetrically, in particular directly next to one another. As a result of this embodiment, the clamping lever has an open shape so that the risk of soil material adhering and plant residues getting caught is significantly reduced. In this embodiment, the tool carrier can have a preferably hook-shaped retaining member, in particular on its rear side, which is configured to retain the clamping lever in a locking position in which the ground cultivation tool and the tool carrier are clamped to one another by way of the clamping lever. In the locking position, the clamping lever can engage behind the retaining element, in particular by way of the loop at its closed end.

The object underlying the disclosure is also satisfied by a ground cultivation tool for a tool change system. The ground cultivation tool can be configured according to one of the above embodiments. It can be provided that the ground cultivation tool be configured to be moved through soil. The ground cultivation tool has at least one receiving recess, by way of which the ground cultivation tool is configured to form an engagement mechanism with a tool carrier so that the ground cultivation tool can be arranged on the tool carrier. According to the disclosure, the ground cultivation tool has a lever receiving recess into which a clamping lever can be inserted. The lever receiving recess can receive a locking section of a clamping lever. With regard to the advantages and modifications of the ground cultivation tool, reference is first made to the advantages and modifications of the above embodiments of the tool change system. The ground cultivation tool can be further developed by features that relate to the ground cultivation tool and which have been explained in the context of the above embodiments of the tool change system.

The object underlying the disclosure is also satisfied by a method of the kind mentioned at the outset, where the engagement mechanism is locked within the scope of the method according to the disclosure by way of a clamping lever of a locking device of the tool change system. The method according to the disclosure is preferably carried out using a tool change system according to one of the embodiments described above so that, with regard to the advantages and modifications of the method according to the disclosure, reference is made to the advantages and modifications of the tool change system according to the disclosure.

### BRIEF DESCRIPTION OF THE DRAWINGS

Preferred embodiments of the disclosure shall be explained and described in more detail below with reference to the accompanying drawings, where

FIG. 1 shows an embodiment of the tool change system according to the disclosure in a pre-locked state;

FIG. 2 shows the tool change system depicted in FIG. 1 in a locked state;

FIG. 3 shows in a sectional illustration of the engagement mechanism of the tool change system depicted in FIG. 1;

FIG. 4 shows a further embodiment of the tool change system according to the disclosure prior to the insertion of the clamping lever;

FIG. 5 shows in a perspective illustration of the tool change system shown in FIG. 4 in a pre-locked state after the insertion of the clamping lever;

FIG. 6 shows in a side view the tool change system depicted in FIG. 4 when the clamping lever is moved to the locking position;

FIG. 7 shows the tool change system depicted in FIG. 4 when the clamping lever is introduced into the retaining member;

FIG. 8 shows in a side view a further embodiment of the tool change system according to the disclosure when the clamping lever is moved to the locking position;

FIG. 9 shows in a perspective illustration a further embodiment of the tool change system according to the disclosure in a pre-locked state after the insertion of the clamping lever;

FIG. 10 shows in a side view the tool change system shown in FIG. 9 when the clamping lever is moved to the locking position; and

FIG. 11 shows the tool change system depicted in FIG. 9 when the clamping lever is moved to the locking position with the aid of an assembly tool.

### DETAILED DESCRIPTION

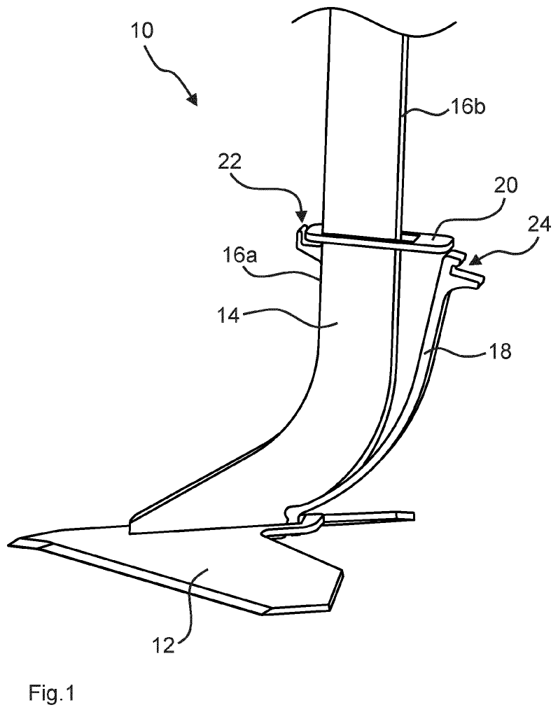

FIG. 1 shows a tool change system 10 for an agricultural ground cultivating machine. Tool change system 10 comprises a ground cultivation tool 12 which is in engagement with a tool carrier 14. Ground cultivation tool 12 can be, for example, a share plate which is moved through the soil at a shallow depth as part of the ground cultivation. Ground cultivation tool 12 has a V-shaped plate shape and is configured as an integrally formed metal body. Tool carrier 14 has an elongate basic shape and is configured as an integrally formed carrier rod made of metal.

Ground cultivation tool 12 and tool carrier 14 can be clamped to one another by way of a clamping lever 18.

FIG. 1 shows tool change system 10 in a pre-locked state in which clamping lever 18 has already been inserted into a (covered) lever receiving recess of an engagement mechanism.

To clamp ground cultivation tool 12 and tool carrier 14 and to lock the engagement mechanism, clamping lever 18 is to be brought into the vicinity of the rear outer edge 16b of tool carrier 14.

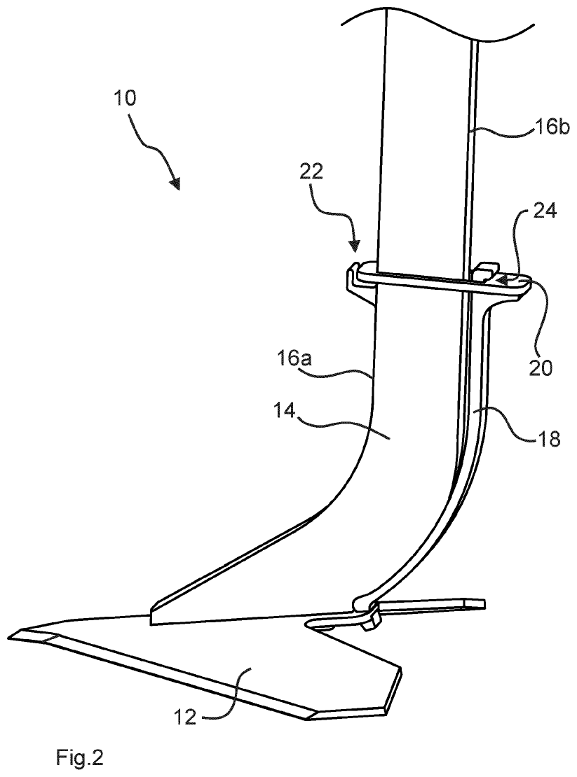

FIG. 2 shows the locked state in which clamping lever 18 is disposed in a locking position and extends along a convexly curved rear end edge 16b of tool carrier 14. Clamping lever 18 can be made to assume the locking position manually and without the use of tools. Tool change system 10 has a retaining member 20 which retains clamping lever 18 in the locking position and prevents clamped clamping lever 18 from snapping back. Retaining member 20 is a ring-shaped body which rests in a front region on a support 22 of tool carrier 14. Support 22 is disposed on front edge 16a of tool carrier 14. Clamping lever 18 has a contour 24 in an upper end region. Contouring 24 consists of an indentation which is formed by two webs of material spaced apart from one another. The indentation of contouring 24 can made to engage with retaining member 20 in order to secure clamping lever 18 in the locking position. If retaining member 20 is not affixed by clamping lever 18, support 22 prevents retaining member 20 from dropping down in an uncontrolled manner. In the locking position depicted, clamping lever 18 is elastically deformed.

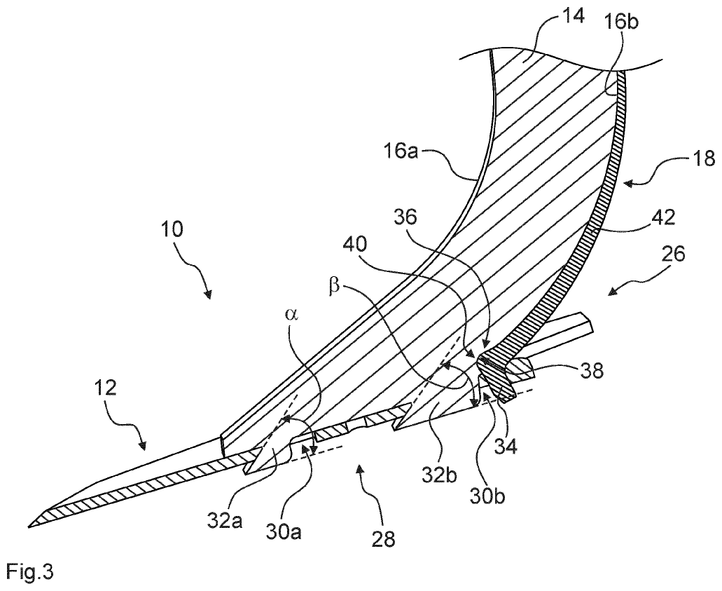

FIG. 3 shows locking device 26 and engagement mechanism 28 in detail. Engagement mechanism 28 is formed by ground cultivation tool 12 and tool carrier 14. Ground cultivation tool 12 and tool carrier 14 can be made to engage with one another in a non-destructively releasable manner by way of engagement mechanism 28. For this purpose, engagement mechanism 28 has two engagement bodies 32a, 32b, where each engagement body 32a, 32b is configured to engage in a receiving recess 30a, 30b of engagement mechanism 28. Engagement bodies 32a, 32b are disposed on the underside of tool carrier 14 and are integral parts of tool carrier 14. Two receiving recesses 30a, 30b are disposed in ground cultivation tool 12. After the insertion of engagement bodies 32a, 32b into receiving recesses 30a, 30b, engagement bodies 32a, 32b protrude only slightly out of receiving recesses 30a, 30b so that engagement bodies 32a, 32b are protected from wear. Engagement bodies 32a, 32b each have a beveled contact surface which are pressed by clamping lever 18 against beveled inner contours of receiving recesses 30a, 30b. The bevels of engagement bodies 32a, 32b and the inner contours of receiving recesses 30a, 30b ensure that ground cultivation tool 12 and tool carrier 14 wedge into one another when they are clamped to one another by way of clamping lever 18. Bevel angles α, β of the bevels of engagement bodies 32a, 32b and the inner contours of receiving recesses 30a, 30b match and in the embodiment shown are 45 degrees.

Clamping lever 18 is part of a locking device 26, by way of which the engagement mechanism can be locked. Clamping lever 18 has a locking section 34 which can be replaced in receiving recess 30b of engagement mechanism 28. Receiving recess 30b can therefore also be referred to as lever receiving recess 30b.

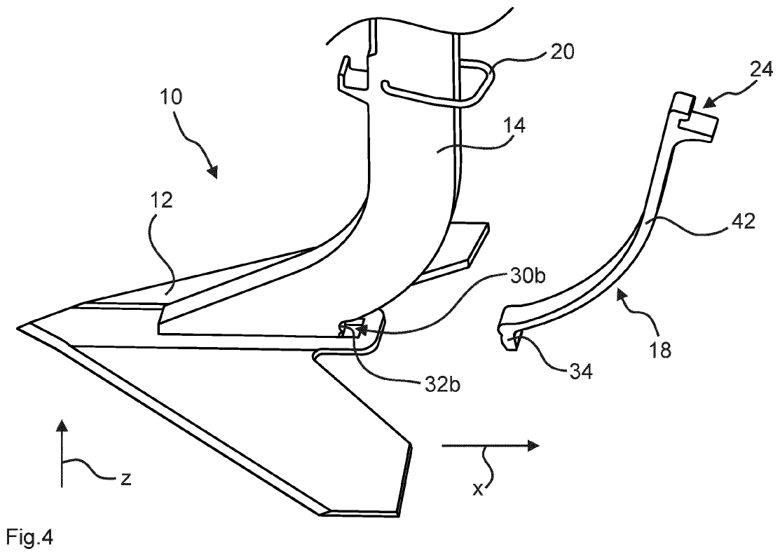

FIGS. 4 to 7 show by way of example the steps required to mount a ground cultivation tool 12. As indicated in FIG. 4, ground cultivation tool 12 must first be made to engage with tool carrier 14. For this purpose, ground cultivation tool 12 is first made to abut in vertical direction z against the lower edge of tool carrier 14. During the vertical motion, ground cultivation tool 12 is positioned in such a way that engagement bodies 32a, 32b of tool carrier 14 are inserted into receiving recesses 30a, 30b of ground cultivation tool 12. Ground cultivation tool 12 is thereafter to be moved backwards in horizontal direction x so that engagement bodies 32a, 32b engage with receiving recesses 30a, 30b. The horizontal motion of ground cultivation tool 12 makes a free region of receiving recess 30b accessible so that locking section 34 of clamping lever 18 can be inserted into receiving recess 30b. Receiving recess 30b is accessible from the rear side of ground cultivation tool 12 after ground cultivation tool 12 and tool carrier 14 have been made to engage so that clamping lever 18 can be inserted into receiving recess 30b from the rear and above.

To complete the locking process, clamping lever 18 must still be moved to a locking position after it has been inserted into lever receiving recess 30b.

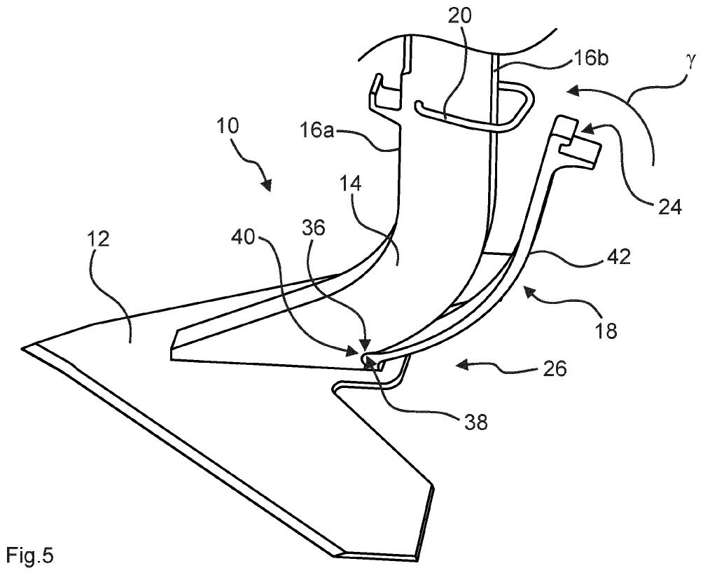

FIG. 5 shows clamping lever 18 while being pivoted to the locking position, where ground cultivation tool 12 and tool carrier 14 are clamped to one another by way of clamping lever 18 while clamping lever 18 is being pivoted. When clamping ground cultivation tool 12 and tool carrier 14, ground cultivation tool 12 is pushed backwards by clamping lever 18. Ground cultivation tool 12 and tool carrier 14 in an initial phase of the clamping process can first perform a motion relative to one another. After the end of the relative motion, a clamping force is built up via clamping lever 18 with which ground cultivation tool 12 and tool carrier 14 are fastened to one another. Clamping lever 18 has a tool contact region which is pressed against the contour of lever receiving recess 30b when ground cultivation tool 12 and tool carrier 14 are clamped to one another. The tool contact region is disposed in locking section 34 of clamping lever 18. When clamping lever 18 is moved to the locking position, the tool contact region of clamping lever 18 is in contact with the contour of lever receiving recess 30b.

Furthermore, clamping lever 18 has a carrier contact region which is pressed against a lever guide region of the tool carrier when ground cultivation tool 12 and tool carrier 14 are clamped to one another. When clamping lever 18 is moved to the locking position, the carrier contact region of clamping lever 18 is in contact with the lever guide region of tool carrier 14. The carrier contact region of clamping lever 18 has a convexly curved contact surface 36. The lever guide region of tool carrier 14 has a concavely curved contact surface 38. Convexly curved contact surface 36 on clamping lever 18 and concavely curved contact surface 38 on tool carrier 14 together form a slide bearing or a rotary bearing 40, respectively. Rotary bearing 40 allows for a guided rotational motion of clamping lever 18 in pivot direction y.

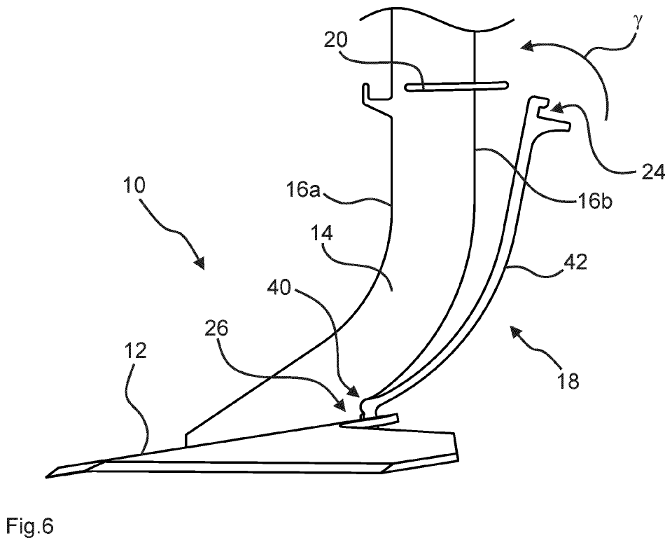

FIG. 6 shows that clamping lever 18 is elastically deformed, namely is elastically bent, in a deformation region 42 when ground cultivation tool 12 and tool carrier 14 are clamped to one another Clamping lever 18 to this end can also be referred to as a spring bar.

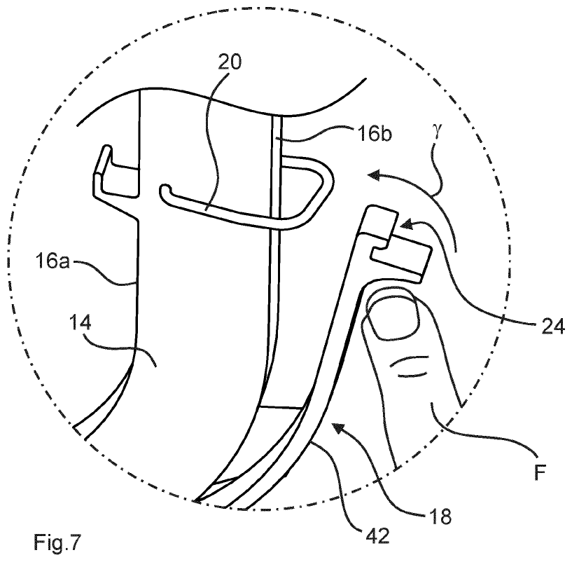

As shown in FIG. 7, moving clamping lever 18 to the locking position and securing clamping lever 18 to retaining member 20 can be effected manually using one or more fingers F. After contouring 24 has been inserted into ring-shaped retaining member 20, clamping lever 18 extends along rear curved edge 16b of tool carrier 14. The curved edge profile of tool carrier 14 is part of a rear end edge 16b of tool carrier 14.

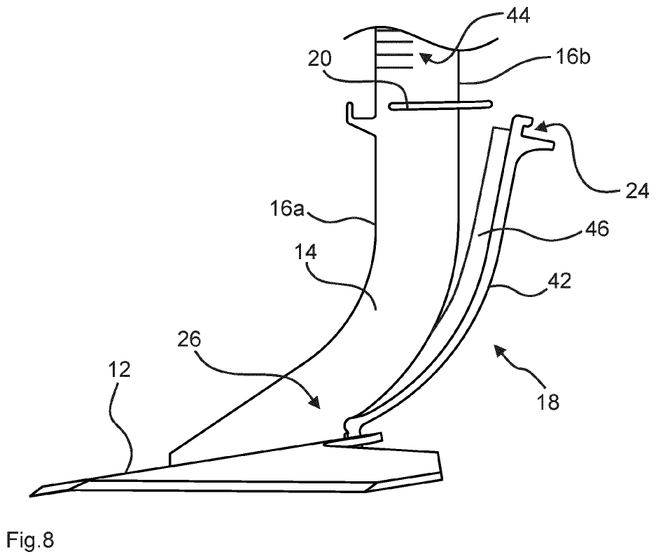

As shown in FIG. 8, elastically deformable material 46, for example, foam rubber, can be arranged on the side of clamping lever 18 facing tool carrier 14. The remaining gap between rear edge 16b of tool carrier 14 and clamping lever 18 can be closed by way of elastically deformable material 46, so that no dirt can collect in this region. Furthermore, markings 44 for setting the position of ground cultivation tool 12 or for setting the working depth can be present on tool carrier 14. Markings 44 form a scale for adjusting the height of ground cultivation tool 12.

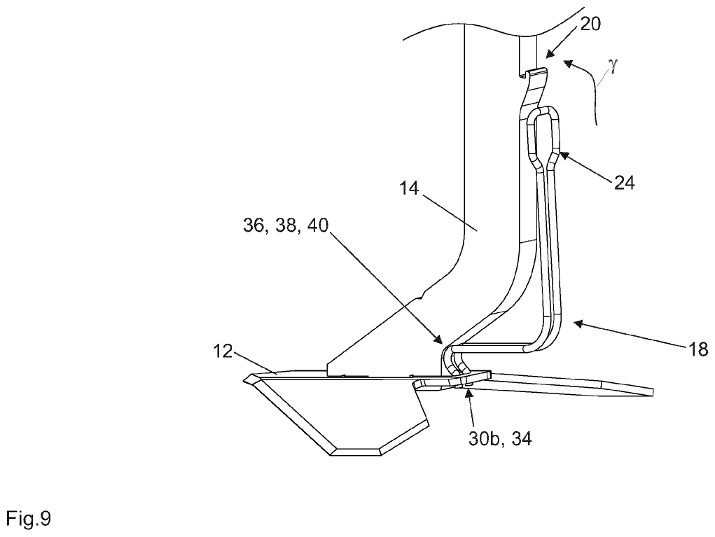

FIG. 9 shows clamping lever 18, which is configured as a bent wire part in this embodiment, while it is being pivoted to the locking position, where ground cultivation tool 12 and tool carrier 14 are clamped to one another by way of clamping lever 18 while clamping lever 18 is being pivoted. When clamping ground cultivation tool 12 and tool carrier 14, ground cultivation tool 12 is pushed backwards by clamping lever 18. Ground cultivation tool 12 and tool carrier 14 in an initial phase of the clamping process can first perform a motion relative to one another. After the end of the relative motion, a clamping force is built up via clamping lever 18 with which ground cultivation tool 12 and tool carrier 14 are fastened to one another. Clamping lever 18 has a tool contact region which is pressed against the contour of lever receiving recess 30b when ground cultivation tool 12 and tool carrier 14 are clamped to one another. The tool contact region is disposed in locking section 34 of clamping lever 18. When clamping lever 18 is moved to the locking position, the tool contact region of clamping lever 18 is in contact with the contour of lever receiving recess 30b.

Furthermore, clamping lever 18 has a carrier contact region which is pressed against a lever guide region of tool carrier 14 when ground cultivation tool 12 and tool carrier 14 are clamped to one another. When clamping lever 18 is moved to the locking position, the carrier contact region of clamping lever 18 is in contact with the lever guide region of tool carrier 14. The carrier contact region of clamping lever 18 has a convexly curved contact surface 36. The lever guide region of tool carrier 14 has a concavely curved contact surface 38. Convexly curved contact surface 36 on clamping lever 18 and concavely curved contact surface 38 on tool carrier 14 together form a slide bearing or a rotary bearing 40, respectively. Rotary bearing 40 allows for a guided rotational motion of clamping lever 18 in pivot direction y.

Clamping lever 18 configured as a bent wire part can also be referred to as a spring clip. Clamping lever 18 is formed to be substantially U-shaped, where the two open ends form locking section 34 of clamping lever 18. A loop therefore arises at the closed end of clamping lever 18 and can serve as contouring 24. By pressing clamping lever 18 in pivot direction y, contouring 24 can engage behind retaining member 20 configured as a hook on tool carrier 14. Clamping lever 18 is retained in its locking position by hook-shaped retaining member 20 once loop-shaped contouring 24 engages therebehind. Clamping lever 18 has a mirror-symmetrical contour, which gives it its open shape.

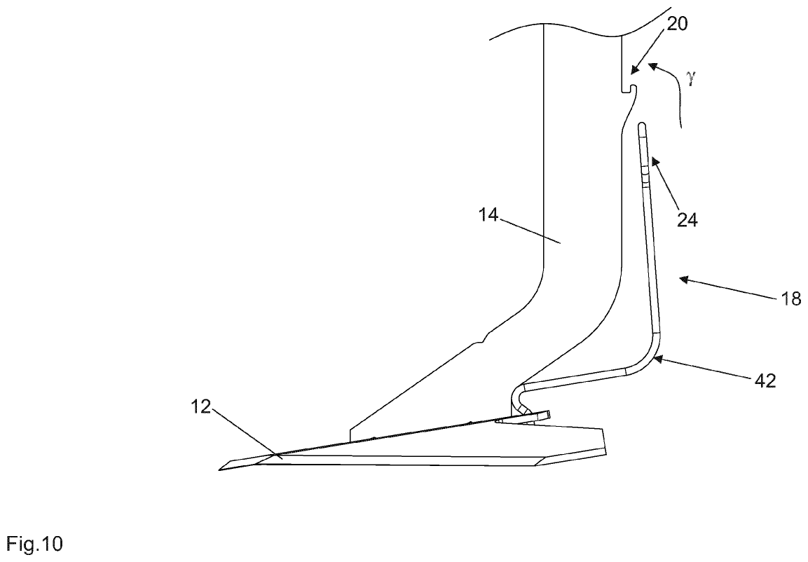

FIG. 10 shows that clamping lever 18 is elastically deformed, namely is elastically bent, in a deformation region 42 when ground cultivation tool 12 and tool carrier 14 are clamped to one another. Clamping lever 18 to this end can also be referred to as a spring clip. Moving clamping lever 18 to the locking position and securing clamping lever 18 on retaining member 20 can be done by manually.

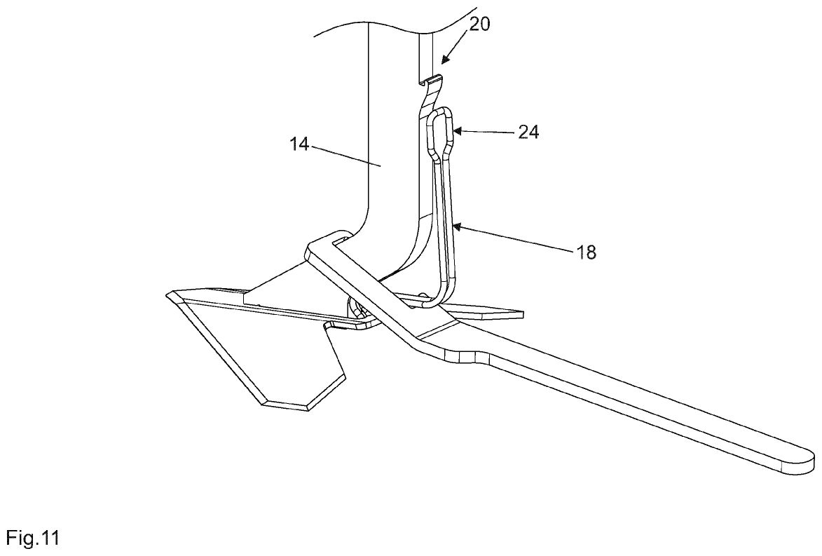

As an alternatively thereto, an assembly tool shown in FIG. 11 can be used for this purpose. The assembly tool can be applied from the side to the front of tool carrier 14 and at the underside of clamping lever 18. For this purpose, it has a lateral opening. By levering the assembly tool, clamping lever 18 can thereafter be moved upwards to its locking position in which contouring 24 engages behind retaining member 20. The assembly tool can also be used to release the locking position.

### REFERENCE CHARACTERS

10 tool change system
12 ground cultivation tool
14 tool carrier
16a, 16b edges
18 clamping lever
20 retaining member
22 support
24 contouring
26 locking device
28 engagement mechanism
30a, 30b receiving recesses
32a, 32b engagement body
34 locking section
36 contact surface
38 contact surface
40 rotary bearing
42 deformation region
44 markings
46 elastic material
α, β bevel angles
y pivot direction
x, z directions of insertion
F finger

1. A Tool change system for agricultural ground cultivating machines, comprising:
a ground cultivation tool which is configured to be moved through soil for ground cultivation;
a tool carrier on which said ground cultivation tool is arranged, and
a locking device;
wherein said ground cultivation tool and said tool carrier together form an engagement mechanism by way of which said ground cultivation tool and said tool carrier can be made to engage with one another in a non-destructively releasable manner; and wherein
said locking device comprises a clamping lever by way of which said engagement mechanism can be locked.

2. A tool change system according to claim 1,
wherein said clamping lever has a locking section which can be inserted into a lever receiving recess of said engagement mechanism, and wherein said lever receiving recess is arranged in said ground cultivation.

3. A tool change system according to claim 1,
wherein said ground cultivation tool and said tool carrier can be clamped to one another by way of a clamping lever.

4. A tool change system according to claim 2,
wherein said clamping lever has a tool contact region which is configured to be pressed against the contour of said lever receiving recess when said ground cultivation tool and said tool carrier are clamped to one another.

5. A tool change system according to claim 3,
wherein said clamping lever has a carrier contact region which is configured to be pressed against a lever guide region of said tool carrier when said ground cultivation tool and said tool carrier are clamped to one another.

6. A tool change system according to claim 5, wherein
said carrier contact region of said clamping lever has a convexly curved contact surface;
said lever guide region of said tool carrier has a concavely curved contact surface.

7. A tool change system according to claim 5, wherein said carrier contact region and said lever guide region together form a rotary bearing for said clamping lever which allows for a guided rotational motion of said clamping lever across a pivot angle range.

8. A tool change system according to one of the above claims, wherein said locking device has a retaining member which is configured to retain said clamping lever in a locking position in which said ground cultivation tool and said tool carrier are clamped to one another by way of said clamping lever.

9. A tool change system according to claim 1, wherein said engagement mechanism has one or more engagement bodies, wherein each engagement body is configured to engage in a receiving recess of said engagement mechanism.

10. A tool change system according to claim 9,
wherein an engagement body of said engagement mechanism is configured to engage in said lever receiving recess into which also said locking section of said clamping lever can be inserted.

11. A tool change system according to claim 9,
wherein said one or more engagement bodies have a contact surface which are each configured to press against a contact section of the inner contour of a receiving recess when said ground cultivation tool and said tool carrier are clamped to one another.

12. A tool change system according to claim 11,
characterized in that wherein said contact surface of said one or more engagement bodies and said contact section of said inner contour of said one or more receiving recesses have corresponding bevels.

13. A tool change system according to at least one of the above claims, characterized in that said clamping lever is configured as a bent wire part, in particular as a spring clip.

14. A ground cultivation tool for a tool change system according to one of the claim 1, which is configured to be moved through soil for ground cultivation, wherein said ground cultivation tool has at least one receiving recess by way of which said ground cultivation tool is configured to form an engagement mechanism with a tool carrier in order to be arranged on said tool carrier, wherein said engagement mechanism includes
a lever receiving recess into which a clamping lever can be replaced.

15. A method for mounting a ground cultivation tool on a soil cultivation machine using a tool change system according to claim 1 comprising:
non-destructively releasing engagement of a ground cultivation tool and a tool carrier with one another by way of an engagement mechanism which is formed together by said ground cultivation tool and said tool carrier; and
locking of said engagement mechanism by way of a clamping lever of a locking device of said tool change system.
